(19) United States
(12) Patent Application Publication
(10) Pub. No.: US 2013/0149425 A1
(43) Pub. Date: Jun. 13, 2013

(54) Product Control Paddles for Snack Food Fryer

(71) Applicant: Heat and Control, Inc., Hayward, CA (US)

(72) Inventors: Andrew A. Caridis, San Carlos, CA (US); John Macrae Silvester, Stanthorpe (AU); Anthony Wade Morris, Belmont, CA (US); Thomas John Miller, Burlingame, CA (US); Enrique Alejandro Leon, Tlajomolca (MX)

(73) Assignee: HEAT AND CONTROL, INC., Hayward, CA (US)

(21) Appl. No.: 13/763,712

(22) Filed: Feb. 10, 2013

Related U.S. Application Data
(63) Continuation-in-part of application No. 12/150,856, filed on Apr. 30, 2008, now abandoned.

(51) Int. Cl. A47J 37/12

(52) U.S. Cl. CPC A47J 37/1276
USPC 426/438; 99/409

(57) ABSTRACT

A method of controlling the movement and separation of snack food products being cooked continuously in a bath of hot cooking oil to the end of realizing a more uniform moisture content in the final product employs a plurality of paddle wheels with blades to rotate in a double action, ratcheting clockwise and counter-clockwise to penetrate and agitate vigorously the product pack. Also disclosed is a variety of paddle wheel configurations and their functions of impeding and urging product flow during cooking.

This is a continuation-in-part of application Ser. No. 12/150,856 filed Apr. 30, 2008.

### FIELD OF THE INVENTION

The present invention concerns cooking snack foods in a hot oil cooking bath in a continuous process and especially relates to controlling and agitating a pack of product during cooking so as to achieve better uniformity in product quality.

### BACKGROUND OF THE INVENTION

In the field of cooking snack foods in a continuous process it has become accepted to rely largely upon the velocity of the cooking oil in the fryer to propel the product through the fryer in the cooking operation. Energy in terms of both heat and velocity is supplied to the cooking oil as it is pumped from a sump in the fryer to a heat exchanger and then returned to the fryer usually at the start of the cooking path or also at locations along that path as needed. Configurations displaying this arrangement are shown in U.S. Pat. Nos. 5,580,598; 5,167,979 and 5,137,740 all of which are owned by the assignee of this invention.

The term “snack food” as used in this disclosure shall be taken to include potato chips, corn and tortilla chips, pellet snacks and the like. In the case of cooking potato chips, raw potato slices are deposited from above into the oil bath of a continuous fryer in a substantial volume to eventually form into a pack. Initially there is a vigorous boil as the water carried on the slice surfaces as well as the moisture contained within the slices boils off. Rotating stirring means known in the field as “paddles”, as well as the cooking oil velocity, serve to urge the mass or pack of potato slices away from the slice inlet and downstream toward the product outlet thereby defining a cooking path.

Uniformity of moisture content in a package of snack foods is a highly desired quality in that it assures the producer that his product, when packaged, will have a longer shelf life as well as good taste and bite when the package is opened and consumed. Assuming the overall goal product moisture content is, for example, 2% there invariably are deviations among items within the package and from package-to-package as well as among production runs. These variations in product moisture contents, in large part, can be attributed to uneven agitation of the product while being cooked. There a large portion of the product will be cooked evenly while a small portion will be under cooked or over cooked. When mixed together in the product packaging operation the resulting combination of proper cooked, under cooked and over cooked product there is created a non uniformity in product moisture content. For the producer the issue becomes how much non uniformity can be tolerated before “off taste” and shorter shelf life become paramount and waste follows. If the moisture content of every slice in the pack is held to a controlled level at a known location in the fryer, the result is very good uniform control over the finish frying stage of the product. Uniform control over the finish frying stage of the product means virtually every chip exits the fryer with the same moisture content. Uniform moisture content of the final product means that some chips are not produced with significantly lower moisture contents than other chips. Noteworthy is that the significantly lower moisture content chip is in danger of having significantly higher acrylamides because it finish fried at a lower moisture content.

Prior art paddles for continuous fryers generally included a motor driven rotatable shaft mounted laterally across the fryer at one or more locations along its length. Arranged on the shaft were “blades” such as generally rectangular sheets of metal configured on the shaft to serve as an impeller. Such paddles, depending upon the direction of their rotational motion, acted to regulate, by somewhat blocking, product flow downstream against the velocity of the cooking oil. Being that the paddles and blades were mounted to extend into the product pack and for a small distance down into the bath of cooking oil, some product slices would work their way around or beneath the paddle blades and receive a shorter cooking time. The result was inconsistency in the product cook time, appearance and moisture content.

The development of acrylamides in snack food containing starch has been noted and studied and may soon become a matter of governmental regulation. See: http://www.cfsan.fda.gov/˜dms/acrydata.html. Potato chips from a variety of well known producers and tested by the U.S. Food and Drug Administration were found to be in the range of a high of 1265 ppb (parts per billion) to a low of 20 ppb of acrylamide. Several animal tests have shown acrylamide to be a carcinogen, and a recent study conducted by the National Food Institute, Technical University of Denmark, has shown a positive association between acrylamide and breast cancer in humans. See: http://en.wikipedia.orgiwiki/Acrylamide. Clearly established when frying carbohydrates in hot cooking oil is the link between product moisture content (around 5%) cooking time and temperature of the oil medium. The research teaches the shorter the cooking time when the product is at or below the critical moisture content, the less acrylamide the will be found in the oil cooked product.

### SUMMARY OF THE INVENTION AND OBJECTS

This invention promotes uniformity of product final moisture content and appearance while minimizing the time for development of acrylamides by providing rotatable, segmented paddle wheel assemblies arranged in a snack food fryer of the continuous cooking oil type wherein the paddle assemblies skirt the bottom of the fryer pan and are controllable to rotate in a variety of modes and speeds. The segmented paddle wheels are of various types including a double break finger type and a double break blade type in four arm and eight arm configurations. A plurality of the segmented paddle wheels arranged in the fryer control progression of the product through the fryer and vigorously mix the product within the pack so that the individual product pieces receive the same exposure to the hot cooking oil for the designed cook time.

A general object of this invention is to create uniformity of final moisture content in a snack food product by ensuring at each stage of cooking that the product receive the same exposure to the cooking oil.

Another object of this invention is to provide a method for cooking snack food products to a uniform designated moisture content thus insuring a uniformity in appearance and taste and a long shelf life.

Still another object of this invention is to provide apparatus arrange to vigorously mix product while cooking as well as urging product to move at a designated rate through a snack food fryer.

Yet another object in view of the prior object is to promote the cooking of a snack food with a desirably low acrylamide content.

A further object is to provide a snack food fryer equipped with novel paddle wheel assemblies operable to aggressively and vigorously agitate, mix and stir the product during cooking to the end of producing a product of uniform final cooked moisture content with good eating properties.

Yet a further object is to provide a fryer capable of successfully frying without washing starchy products which normally stick together unless washed to remove the glue producing surface starch and to eliminate the use of costly, and in many cases scarce water. Starch retained within and upon the product enhances product flavour and texture and in this system does not contamination water effluent.

Still another object of this invention is to provide in a snack food fryer which due to the vigorous paddle action separates the product slices promoting excellent heat transfer to the product resulting in reduced product frying time in excess of 30%. Example: potato chips prepared in prior art fryers require a cook time of 3 minutes, 20 seconds. With the disclosed invention the cooking time with the identical stating materials is 2 minutes, 15 seconds.

These and other objects of the invention will become apparent from a consideration of the specification text when considered with the following drawings.

### BRIEF DESCRIPTION OF THE DRAWINGS

FIG. 1 illustrates in a fragmentary elevation view of a continuous oil fryer having installed therein novel apparatus capable of performing the process of the present invention;

FIG. 2 is a plan view of the apparatus of FIG. 1;

FIG. 3A is an enlarged, perspective view of one version of an eight blade segmented paddle wheel assembly useful in the present invention;

FIG. 3B is a view on the scale of FIG. 3A showing the segmented paddle wheel of FIG. 3A and as shown on a smaller scale in FIG. 1;

FIG. 4 is a view like FIG. 3A showing another form of segmented paddle wheel, this having four blades each with a double break;

FIG. 5 is a view like FIG. 3A showing still another form of segmented paddle wheel, this having four blades each having received a single break;

FIG. 6 is an enlarged perspective view of yet another form of segmented paddle wheel, this having four double break fingers-like tines;

FIG. 9 is an enlarged perspective view showing anther form of segmented paddle wheel with the blades extending from a rotatable drum.

FIG. 10 is view like FIG. 2 illustrating servo motor equipped paddle wheels in circuit with a servo drive controller; and

FIG. 11 is view like FIG. 1 but illustrating the shifting rotational movements of a single paddle wheel in a controlled, double action of rocking agitation and product mixing together with product advancement within a cooker.

### DETAILED DESCRIPTION OF THE PREFERRED EMBODIMENTS

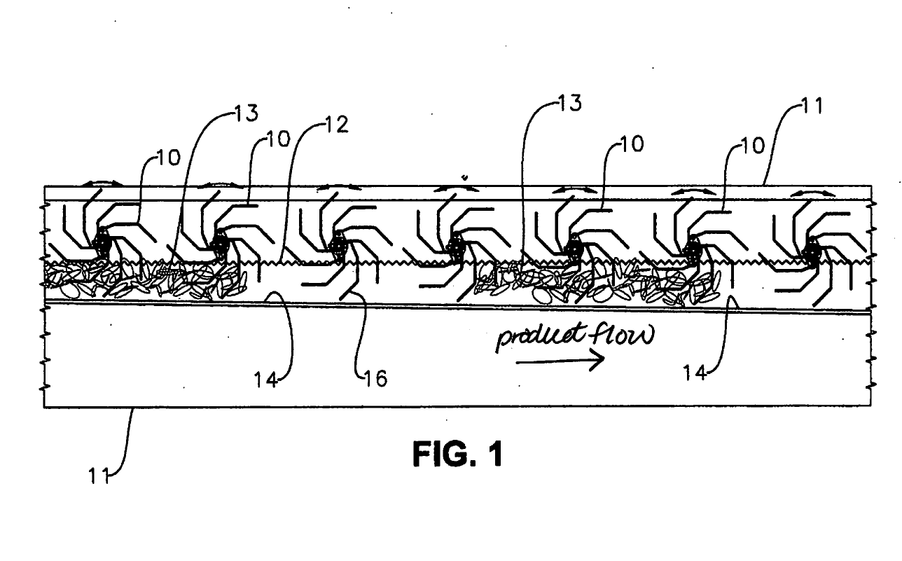

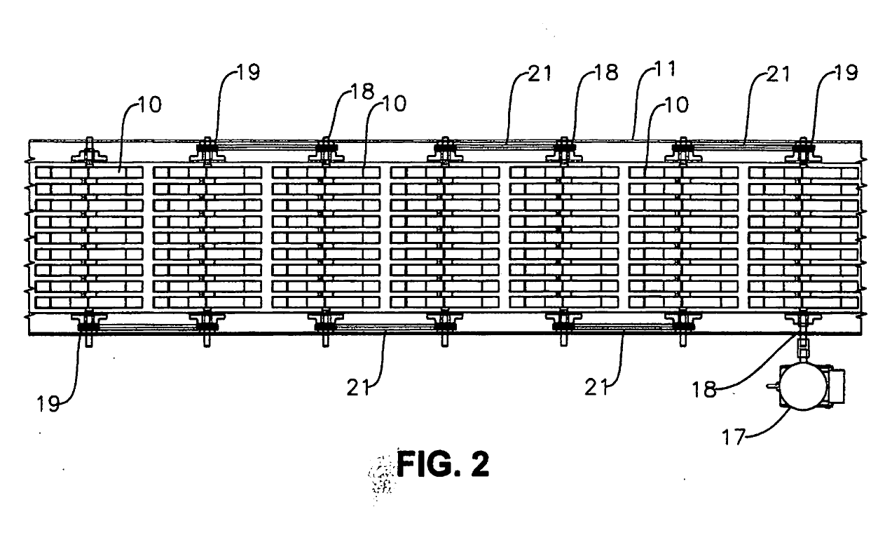

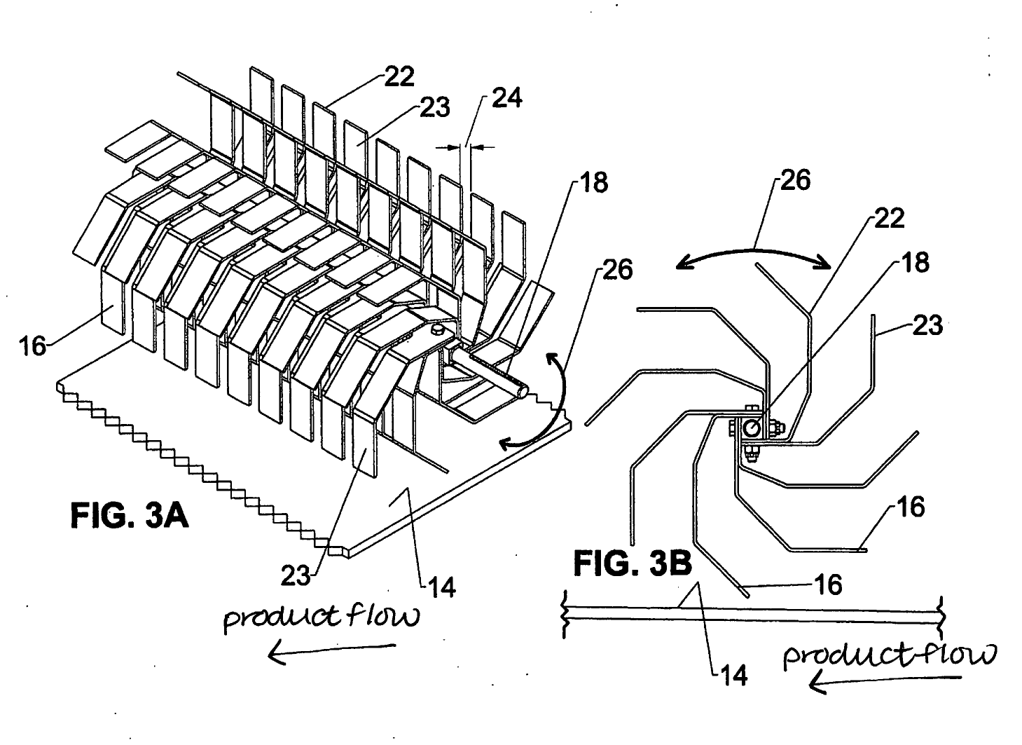

Referring to FIGS. 1 and 2 of the drawings, an array of segmented product control paddles 10, made in accordance with and operable within the principles of the present invention, is shown mounted in a fryer 11 of the continuous oil bath type. For reasons of brevity and conciseness, the fryer 11 is illustrated in fragment format as a representative section but the operational hot cooking oil level 12 is indicated by a wavy line and a partial pack of snack food product 13 is depicted immersed in the oil 12 at only two locations. However, it shall be understood irrespective of this illustration that the fryer 11 is continuously charged with product 13 and cooks a pack of product throughout its full length in the normal cooking operation. To be noted from FIG. 1 and also reflected in FIGS. 3A and 3B, is that the inside bottom surface 14 of the fryer 11 and the lower tips of the segmented paddle blades 16 are spaced relatively close together so that the blades 16 may sweep product fines along the bottom 14 as well as to preclude any but an insignificant quantity of the product 13 from moving beneath the rotating paddle blades. The action of the blades 16 sweeping the bottom surface creates a high velocity of oil flow thereby flushing the fines towards the discharge end then out into the fines catch box (not shown) for sediment removal. Well understood in the field of continuous fryers is that hot cooking oil is pumped into the fryer from a remote heat exchanger. The kinetic energy of the hot oil is the principal driving force serving to move the snack food product through the fryer 11. The hot oil is introduced into the fryer pan, usually but not invariably, at the product feed end.

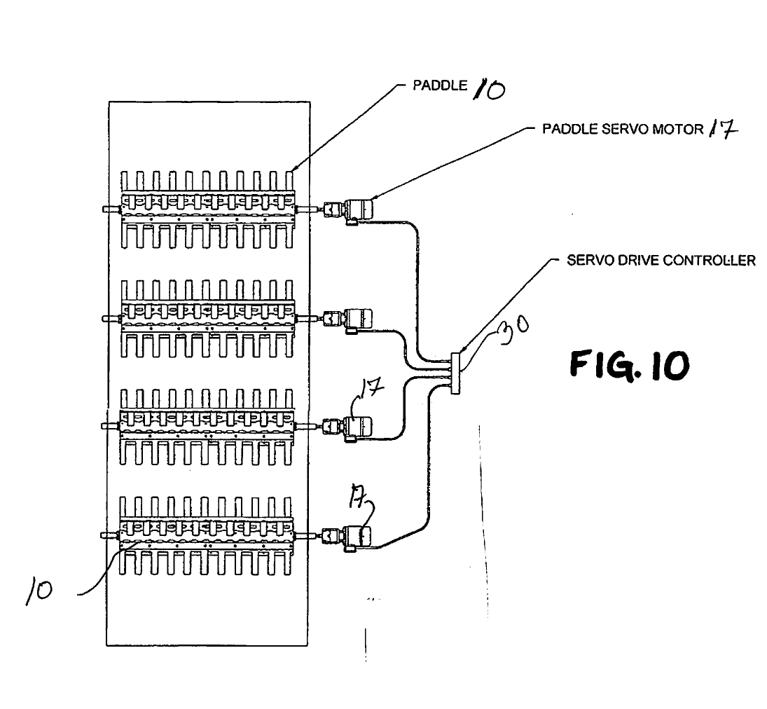

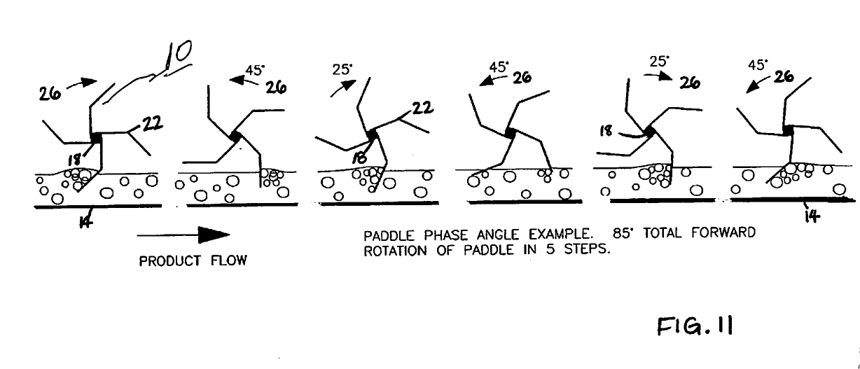

Referring to FIG. 2 and FIG. 10 in association with FIG. 1, the array of segmented product control paddles 10 comprise four (FIG. 10) or seven (FIG. 2) paddle wheels but these numbers are only for illustration while in an operating fryer 11 the number of segmented paddles may vary widely depending on the application (fryer size, product type or load and degree of agitation required) from as few as two to as many as twenty-two. A successful system for driving the segmented paddle wheels 10 is a sprocket and drive chain arrangement as indicated in FIG. 2. This arrangement includes a variable speed drive motor 17 coupled to a paddle wheel shaft 18, the opposite end of which is equipped with a chain sprocket 19 upon which is reeved a drive chain 21 that runs to a similar sprocket and paddle wheel shaft on the next successive paddle wheel assembly. The other paddle wheel are similarly equipped so that the drive motor 17 may drive all the paddle wheels in the array.

Alternatively, referring to FIG. 10, each individual segmented paddle wheel 10 may be driven by a dedicated programmable drive motor 17 so that the rotational speeds and oscillations of the segmented paddle wheels may be selected to suit widely varying conditions. In such a configuration and referring specifically to FIG. 11, the segmented paddle wheels may rotate alternately clockwise and then counter-clockwise as indicated by the arrows 26 to achieve the objectives of controlling with incremental advancement the forward movement of the product pack 13 against the forces of the cooking oil pumped into the fryer and being withdrawn at another location. This rotational back and forth action of the segmented paddles 10 in a ratching action also generates violent agitation of the pack of product in a vigorous manner. Further it separates slices from each other thereby permitting the cooking oil to reach all surfaces of the individual product pieces.

Ratcheting double action, product agitation through rotation and counter-rotation of the segmented paddle wheels, FIG. 11, is vigorous given that the paddles may rotate in the range of ½ RPM to about 20 RPM as programmed in the servo drive controller 30 in the circuit illustrated in FIG. 10. This assists in promoting even exposure of the product to the cooking oil throughout the pack with the expected result being a very even product moisture content at every point along the cooking path. The release of entrapped steam from the product pack generated in the cooking operation is a benefit of the design and operation of the present invention. The provision for steam escape from the pack enables a much shorter cooking time. We have been able to obtain repeatable final moisture results as intended and typical for different products. This in turn insures much better product shelf live when all of the product pieces within a package are at the same desired final moisture content.

FIGS. 3 A and 3 B display an eight blade, segmented paddle wheel 22 which is a more detailed representation of the paddle wheels 10 indicated in FIGS. 1 and 2. Each of the eight blades 23 is formed from gauge sheet metal which has been subjected to two treatments in a metal break, hence the term two break blades. The breaks or metal deformations of the blade are each at about an angle of 135 degrees so that the tip or end of the blade 23 is at about an angle of 90 degrees from its base attachment location on the shaft 18. The space or slot 24 between adjacent blades 23 can be selected to be less that the apparent width of the general width of a product piece, ½ inches to 1¼ inches being satisfactory in discouraging product passing through the slot or gap 24 while permitting cooking oil flow there through. The breadth of the blades 23 while being effective in controlling and agitating the product pack also serves to restrain the tendency of the product to be carried freely by the flowing cooking oil. Hence it impedes and assists in regulation of product flow along the cooking path.

As indicated by the arrows 26 in FIGS. 3 A & 3 B, and in FIG. 11, the segmented paddle wheel 22 may be rotated in the clockwise and in the counter-clockwise direction. Looking at FIG. 3 B, the snack food product flow in the fryer is indicated by the arrow and legend (the cooking path), rotation of the segmented paddle wheel 22 in a counter clock wise direction serves to resist motion of the product pack (not shown). When rotated in the clock wise direction, the paddle wheel 22 serves aggressively to grab into the product pack, stirring it and shifting products into another positions within the pack. Thus there are benefits in rotating the segmented paddle wheel in a ratcheting rotational pattern, FIG. 11, as well as rotating in and oscillating, first one way then the opposite way, pattern. The result is vigorous agitation and mixing of the snack food product within the pack during the cooking operation.

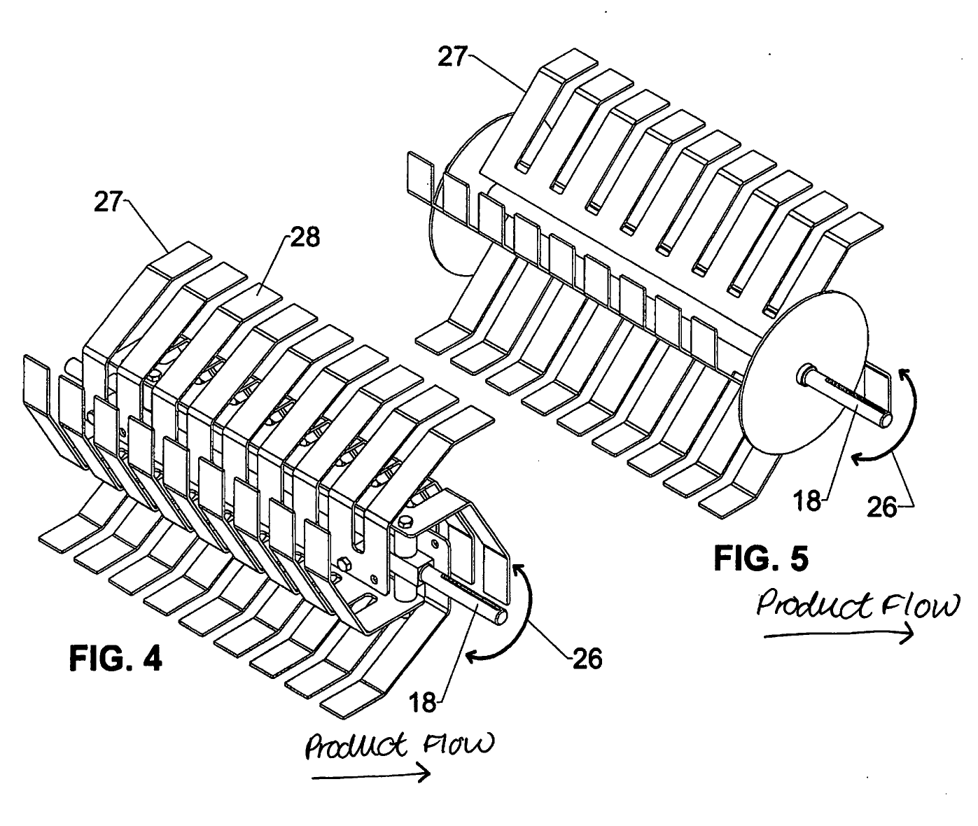

FIGS. 4 and 5 are illustrations of a four blade segmented paddle wheel 27 which is a more detailed representation of another of the paddle wheels 10 indicated in FIGS. 1 and 2. Each of the four blades 28 is formed from gauge sheet metal which has been subjected to two treatments in a metal break, hence the term two break blades, all as described above in connection with blades 23. The four blade configuration can serve the basic functions described above in connection with the paddled wheel 22 but in this case has a more aggressive action when digging into the flowing product pack taking action on a larger segment of product for mixing and agitation as the paddle wheel 27 rotates in the direction of product flow.

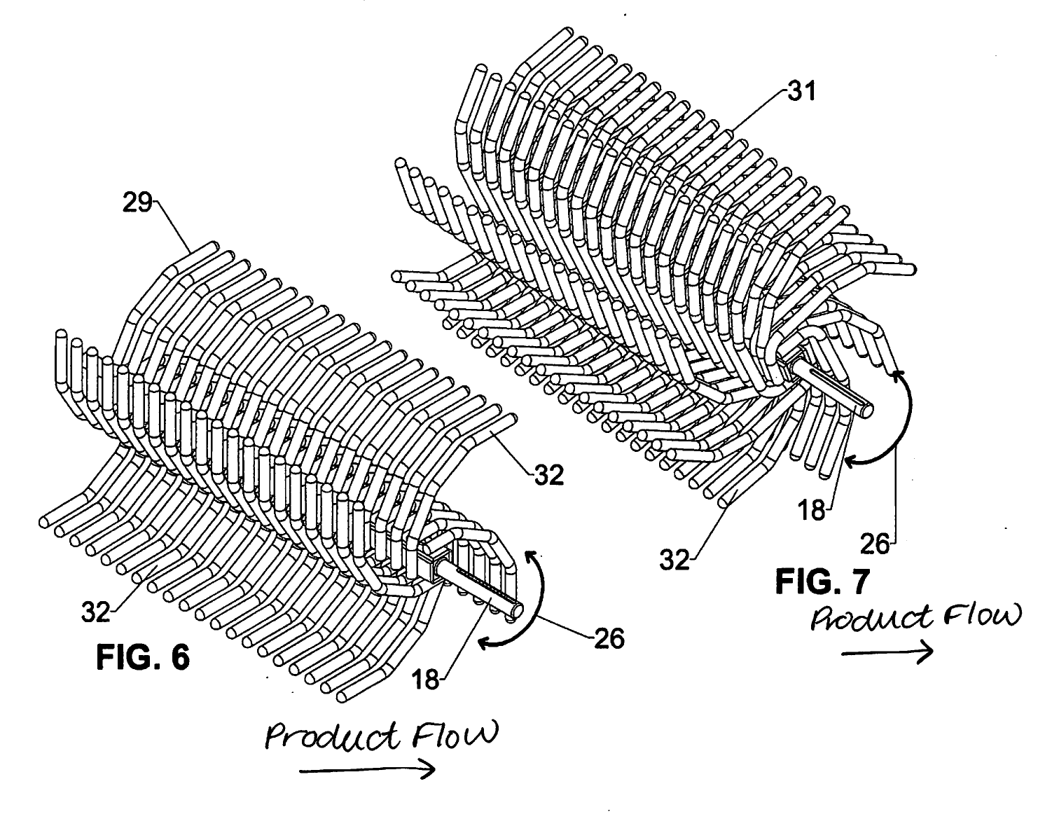

FIGS. 6 and 7 show two other forms 29 and 31 of segmented paddle wheels, these with the presentation of finger-like blades or tines 32 extending radially from the central axle shaft 18 which is rotatable as indicated by the directional arrows 26. Each of these tines or blades 32 were bent so as to extend into at least three planes transverse to the shaft 18, having been subjected to at least three breaks during manufacture. When visualized in an end view it will be recognized that the tines or blades 32 take on a “S” curve configuration formed about the shaft 18. An important characteristic and function of the of the finger-like blades is that they afford a vigorous agitation and mixing of the product pack promoting uniform contact with the cooking oil and eliminating clumps of stuck together product, an undesirable condition.

FIG. 8 shows yet another form 33 of segmented paddle wheel which is a more detailed representation of the paddle wheels 10 indicated in FIGS. 1 and 2.

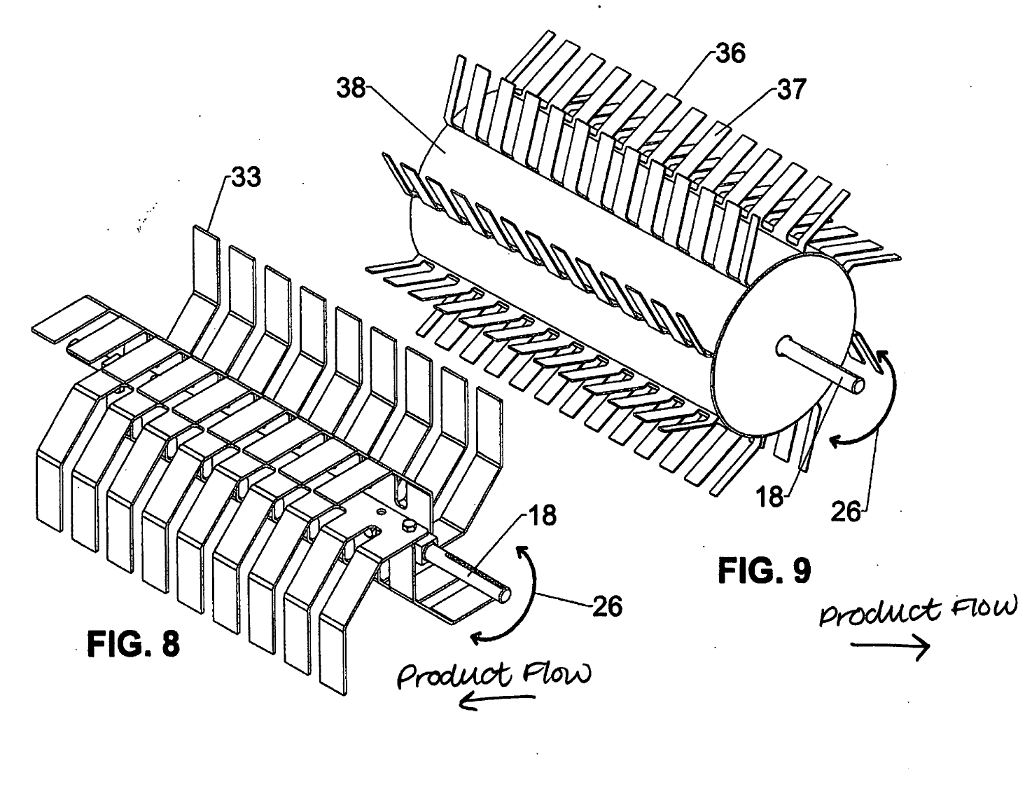

FIG. 9 shows still another form 36 of segmented paddle wheel which is a more detailed representation of the paddle wheels 10 indicated in FIGS. 1 and 2. Here the blades 37 are mounted to extend from the surface a cylinder or drum 38. The drum serves to push down on the product pack while the blades 37 “work the pack” in a vigorous agitated manner.

It will be readily apparent that various modifications may be made to the structures and processes of this invention and still be within the scope of the present invention. In particular, in may be readily appreciated by those skilled in this art from the above description that the apparatus according to the invention provides for adjustability not only in the available rotational speeds of the segmented paddle wheels but in the fractional rotational movements, FIG. 11, as well as the oscillation rates of the paddle wheels. This feature of controlled adjustability accords with better cooking times and the resulting uniformity of the final product moisture content. For example, potato chips cooked in a prior art fryer cooked in a typical time of 3 minutes, 20 seconds. This contrasts with a much shorter cook time of 2 minutes, 15 seconds using the process and apparatus of the present invention. An advantageous result of the subject process is to permit cooking of unwashed slices of product. Heretofore washing uncooked slices was needed with the unfavourable need of disposing of the contaminated wash water. This has now be eliminated and is an ecological benefit of this invention.

Accordingly, the scope of this invention shall only be limited within terms and spirit of the following claims.

What is claimed is:

1. The process of controlling the flow of product in a snack food fryer so as to promote uniformity of product final moisture content and appearance while minimizing development of acrylamides, comprising the steps:
providing in a snack food fryer equipped with a substantially planar bottom a bath of cooking oil at cooking temperature flowing to move the product along a cooking path towards a station of product discharge from the fryer;
introducing a continuous supply of uncooked snack food product into the flow of cooking oil so as to develop a pack of product cooking in the fryer;
controlling the forward movement of the pack against the forces of the moving cooking oil with an array of segmented rotatable paddles having blades positioned closely spaced from the fryer bottom a distance that precludes product movement beneath the blades, and
rotating ones of the paddles in the array of paddles in an oscillating, reciprocating rocking action alternately in the direction contra to and then local with the oil flow, thereby ensuring vigorous agitated stirring and mixing of the product pack and promoting substantially uniform cooking by releasing entrapped steam from the product pack during product movement towards the discharge station.

2. The cooking process of claim 1 wherein a sub-set in the array of the segmented paddles is rotated in a double action oscillating pattern so as to rotate in a ratcheting action both in the direction of cooking oil flow as well as opposed to that direction thereby to enable rapid agitation and vigorous mixing within the pack for release of steam afford efficient heat transfer from the cooking oil to the products for a shorter cook time.

3. Improved apparatus for use in a continuous snack food, hot oil fryer, comprising:
a plurality of segmented paddle wheels transversely mounted in the fryer for rotation in a manner to control the flow of product in the fryer when impelled by the velocity of the current of cooking oil;
each paddle wheel including a central shaft;
motor means serving to drive the paddle wheel shaft such that the paddle wheel rotates at a defined rotational speed; and
a plurality of blades projecting from the central shaft portion of each paddle wheel, the individual blades being spaced apart so that their adjacent edges define a slot for oil passage there-through as the wheel is rotated and thereby present a segmented array of blades to the cooking oil and snack food product flowing through the fryer, permitting passage of the cooking oil through the slot while precluding product movement there-through.

4. The improved apparatus of claim 3 wherein certain of the paddle wheels include finger-like blades each bent to extend from the shaft in two different planes that when two fingers mounted oppositely to each other on the shaft define an “S” configuration.

5. The improved apparatus of claim 3 wherein certain of the paddle wheels include a drum mounted to the shaft, said plurality of blades extending radially outwardly from the drum, said blades being configured with at least two breaks.

6. The improved apparatus of claim 3 wherein the segmented paddle wheels are configured for mounting in the fryer such that when rotated the blades sweep the bottom surface of the fryer pan thereby to move fines along the bottom surface while allowing cooking oil flow and precluding product from passage beneath the paddle wheels.

7. In combination with a snack food fryer of the of the continuous production type containing a volume of cooking oil wherein the cooking oil is heated remotely from the fryer and delivered to the fryer with such velocity as to urge a pack of snack food product being cooked along a cooking path, apparatus including,
a plurality of segmented paddle wheels rotatably mounted in the fryer so as to impede movement of the product against the velocity of cooking oil,
motor means to induce rotation of the paddle wheels at a speed causing vigorous agitation of snack food product passed through the fryer,
the paddle wheels including blade elements extending through the pack of snack food and positioned to preclude individual pieces of snack food to pass beneath the wheels,
the blade elements being spaced laterally apart a distance forming a barrier for product movement there-through while permitting cooking oil flow along the cooking path, thus controlling product movement in the fryer and affording substantially uniform cooking through out the product pack.

8. The combination of claim 7 wherein the segmented paddle wheels are of first and second types including a first type with flat, forward facing blades and a second type with “S” shaped finger combinations serving for violent agitation of snack food product in the cooking oil.

9. The combination of claim 7 wherein the said motor means serves to rotate a first group of segmented paddles in a direction concurrent to the path of product movement and a second group of segmented paddles in a direction counter-current to the path of product movement to the end of imposing violent agitation in the pack of snack food products being cooked in the fryer.

10. The combination of claim 7 wherein the rotational speed of the segmented paddle wheels in a range of from about 0.5 RPM to about 20 RPM.
